(19) United States
(12) Patent Application Publication
(10) Pub. No.: US 2010/0211192 A1
(43) Pub. Date: Aug. 19, 2010

(54) APPARATUS AND METHOD FOR AUTOMATED ANALYSIS OF ALARM DATA TO SUPPORT ALARM RATIONALIZATION

(75) Inventors: Petr Stluka, Prague (CZ); Petr Cisar, Suchdol nad Luznici (CZ); Eva Hostalkova, Usti nad Labem (CZ)

Correspondence Address: HONEYWELL/MUNCK;Patent Services, 101 Columbia Road, P.O. Box 2245, Morristown, NJ, 07962-2245, US

(73) Assignee: Honeywell International Inc., Morristown, NJ (US)

(21) Appl. No.: 12/634,425

(22) Filed: Dec. 9, 2009

Related U.S. Application Data
(60) Provisional application No. 61/153,244, filed on Feb. 17, 2009.

(51) Int. Cl. G06F 17/30; G05B 11/01

(52) U.S. Cl. 700/12; 707/771; 707/722; 707/E17.014; 700/21; 707/E17.002

(57) ABSTRACT

A method includes receiving at least one search parameter, where the at least one search parameter defines one or more restrictions on types of event patterns. The method also includes searching a collection of historical events associated with a process control system. The method further includes identifying one or more groups of alarms each having a pattern that satisfies the one or more restrictions. In addition, the method includes outputting information identifying the one or more groups of alarms. The method could also include receiving a selection of at least one of the one or more identified groups of alarms. The method could further include notifying one or more components in the process control system to begin dynamically suppressing alarms in the at least one selected group of alarms.

### CROSS-REFERENCE TO RELATED APPLICATIONS

This application claims priority under 35 U.S.C. §119(e) to U.S. Provisional Application No. 61/153,244 filed on Feb. 17, 2009, which is hereby incorporated by reference.

### TECHNICAL FIELD

This disclosure relates generally to process control systems and more specifically to an apparatus and method for automated analysis of alarm data to support alarm rationalization.

### BACKGROUND

Processing facilities are often managed using process control systems. Example processing facilities include manufacturing plants, chemical plants, crude oil refineries, and other processing plants. Among other operations, process control systems typically manage the use of industrial equipment in the processing facilities.

An alarm system is routinely used to generate alarms when problems or other issues in a processing facility are detected. However, a poorly functioning alarm system can easily generate alarm floods, or situations where the rate of alarms is higher than an acceptable level. As a result of an alarm flood, more alarms are generated over a given period of time than can be responded to by a human operator. Alarm floods are often noted as a contributing factor to serious upsets, incidents, and major accidents in processing facilities.

This problem can be addressed by executing “alarm rationalization” processes that focus on improvements in the alarm systems. One objective is to prevent human errors caused by improperly configured alarm systems that generate alarm floods. Alarm rationalization can involve relatively simple techniques, such as making changes to alarm configurations or removing duplicated alarms. Alarm rationalization can also involve more sophisticated techniques, such as dynamic alarm suppression.

Some practical challenges when implementing alarm rationalization processes are cost, scope, and human factors. Cost can be an issue since alarm rationalization routinely involves a long-term effort by a team of specialists. Scope can be an issue since thousands of alarms often need to be reviewed one by one. Human factors can be an issue since identifying alarm improvements is often done by a team of human beings who may have biased views and can make errors.

### SUMMARY

This disclosure provides an apparatus and method for automated analysis of alarm data to support alarm rationalization.

In a first embodiment, a method includes receiving at least one search parameter, where the at least one search parameter defines one or more restrictions on types of event patterns. The method also includes searching a collection of historical events associated with a process control system. The method further includes identifying one or more groups of alarms each having a pattern that satisfies the one or more restrictions. In addition, the method includes outputting information identifying the one or more groups of alarms.

In a second embodiment, an apparatus includes a processing device configured to receive at least one search parameter, where the at least one search parameter defines one or more restrictions on types of event patterns. The processing device is also configured to search a collection of historical events associated with a process control system and identify one or more groups of alarms each having a pattern that satisfies the one or more restrictions. The apparatus also includes a memory device configured to store information identifying the one or more groups of alarms.

In a third embodiment, a computer readable medium embodies a computer program. The computer program includes computer readable program code for receiving at least one search parameter, where the at least one search parameter defines one or more restrictions on types of event patterns. The computer program also includes computer readable program code for searching a collection of historical events associated with a process control system. The computer program further includes computer readable program code for identifying one or more groups of alarms each having a pattern that satisfies the one or more restrictions. In addition, the computer program includes computer readable program code for outputting information identifying the one or more groups of alarms.

Other technical features may be readily apparent to one skilled in the art from the following figures, descriptions, and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates an example process control system according to this disclosure;

FIG. 2 illustrates an example method for alarm rationalization using an alarm rationalization tool according to this disclosure; and

FIGS. 3 through 12 illustrate example details associated with an alarm rationalization tool according to this disclosure.

### DETAILED DESCRIPTION

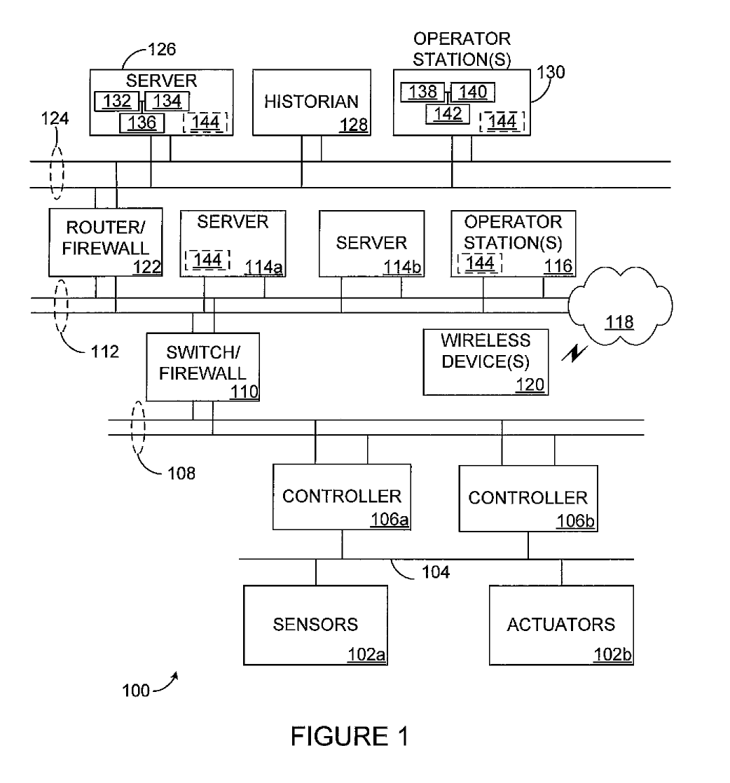

FIGS. 1 through 12, discussed below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

FIG. 1 illustrates an example process control system 100 according to this disclosure. In this example embodiment, the process control system 100 includes various components, such as one or more sensors 102a and one or more actuators 102b, facilitating production or processing of at least one product or material. The sensors 102a and actuators 102b represent components in a process system that may perform any of a wide variety of functions. For example, the sensors 102a could measure a wide variety of characteristics in the process control system 100, such as temperature, pressure, or flow rate. Also, the actuators 102b can perform a wide variety of operations that alter the characteristics being monitored by the sensors 102a. As particular examples, the actuators 102b could represent electrical motors, hydraulic cylinders, or transducers. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system. Also, a process system may generally represent any system or portion thereof configured to process one or more products or other materials in some manner.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

Two controllers 106a-106b are coupled to the network 104. The controllers 106a-106b may, among other things, use the measurements from the sensors 102a to control the operation of the actuators 102b. For example, the controllers 106a-106b could receive measurement data from the sensors 102a and use the measurement data to generate control signals for the actuators 102b. Each of the controllers 106a-106b includes any hardware, software, firmware, or combination thereof for interacting with the sensors 102a and controlling the actuators 102b. The controllers 106a-106b could, for example, represent multivariable controllers or other types of controllers that implement control logic (such as logic associating sensor measurement data to actuator control signals) to operate. Each of the controllers 106a-106b could, for example, represent a computing device running a MICROSOFT WINDOWS operating system.

Two networks 108 are coupled to the controllers 106a-106b. The networks 108 facilitate interaction with the controllers 106a-106b, such as by transporting data to and from the controllers 106a-106b. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

Two servers 114a-114b are coupled to the networks 112. The servers 114a-114b perform various functions to support the operation and control of the controllers 106a-106b, sensors 102a, and actuators 102b. For example, the servers 114a-114b could log information collected or generated by the controllers 106a-106b, such as measurement data from the sensors 102a or control signals for the actuators 102b. The servers 114a-114b could also execute applications that control the operation of the controllers 106a-106b, thereby controlling the operation of the actuators 102b. In addition, the servers 114a-114b could provide secure access to the controllers 106a-106b. Each of the servers 114a-114b includes any hardware, software, firmware, or combination thereof for providing access to, control of, or operations related to the controllers 106a-106b. Each of the servers 114a-114b could, for example, represent a computing device running a MICROSOFT WINDOWS operating system.

One or more operator stations 116 are coupled to the networks 112. The operator stations 116 represent computing or communication devices providing user access to the servers 114a-114b, which could then provide user access to the controllers 106a-106b (and possibly the sensors 102a and actuators 102b). As particular examples, the operator stations 116 could allow users to review the operational history of the sensors 102a and actuators 102b using information collected by the controllers 106a-106b and/or the servers 114a-114b. The operator stations 116 could also allow the users to adjust the operation of the sensors 102a, actuators 102b, controllers 106a-106b, or servers 114a-114b. In addition, the operator stations 116 could receive and display warnings, alerts, or other messages or displays generated by the controllers 106a-106b or the servers 114a-114b. Each of the operator stations 116 includes any hardware, software, firmware, or combination thereof for supporting user access and control of the system 100. Each of the operator stations 116 could, for example, represent a computing device running a MICROSOFT WINDOWS operating system.

In this example, the system 100 also includes a wireless network 118, which can be used to facilitate communication with one or more wireless devices 120. The wireless network 118 may use any suitable technology to communicate, such as radio frequency (RF) signals. Also, the wireless devices 120 could represent devices that perform any suitable functions. The wireless devices 120 could, for example, represent wireless sensors, wireless actuators, and remote or portable operator stations or other user devices.

At least one router/firewall 122 couples the networks 112 to two networks 124. The router/firewall 122 includes any suitable structure for providing communication between networks, such as a secure router or combination router/firewall. The networks 124 could represent any suitable networks, such as a pair of Ethernet networks or an FTE network.

In this example, the system 100 includes at least one additional server 126 coupled to the networks 124. The server 126 executes various applications to control the overall operation of the system 100. For example, the system 100 could be used in a processing plant or other facility, and the server 126 could execute applications used to control the plant or other facility. As particular examples, the server 126 could execute applications such as enterprise resource planning (ERP), manufacturing execution system (MES), or any other or additional plant or process control applications. The server 126 includes any hardware, software, firmware, or combination thereof for controlling the overall operation of the system 100.

A historian 128 is also coupled to the networks 124. The historian 128 generally collects information associated with the operation of the system 100. For example, the historian 128 may collect measurement data associated with the operation of the sensors 102a. The historian 128 may also collect control data provided to the actuators 102b. The historian 128 may collect any other or additional information associated with the process control system 100, such as alarms generated in the system 100 and operator actions taken in response to the alarms. The historian 128 includes any suitable storage and retrieval device or devices, such as a MY SQL or other database.

One or more operator stations 130 are coupled to the networks 124. The operator stations 130 represent computing or communication devices providing, for example, user access to the servers 114a-114b, 126 and the historian 128. Each of the operator stations 130 includes any hardware, software, firmware, or combination thereof for supporting user access and control of the system 100. Each of the operator stations 130 could, for example, represent a computing device running a MICROSOFT WINDOWS operating system.

In particular embodiments, the various servers and operator stations may represent computing devices. For example, each of the servers 114a-114b, 126 could include one or more processors 132 and one or more memories 134 for storing instructions and data used, generated, or collected by the processor(s) 132. Each of the servers 114a-114b, 126 could also include at least one network interface 136, such as at least one Ethernet interface. Also, each of the operator stations 116, 130 could include one or more processors 138 and one or more memories 140 for storing instructions and data used, generated, or collected by the processor(s) 138. Each of the operator stations 116, 130 could also include at least one network interface 142, such as at least one Ethernet interface.

In one aspect of operation, at least one alarm rationalization tool 144 is provided. For example, the process control system 100 can execute one or more instances of the alarm rationalization tool 144. The alarm rationalization tool 144 could be executed by any suitable component(s) in the system 100 (such as by one or more servers or operator stations) or executed outside of the system 100.

The alarm rationalization tool 144 performs various functions supporting alarm rationalization. For example, methods for dynamically suppressing alarms can include mode-based suppression and event-based suppression. In mode-based suppression, groups of alarms are automatically suppressed depending on specific process and equipment conditions (called modes or states). In event-based suppression, groups of alarms are dynamically suppressed based on detected process or equipment conditions and triggering events. In both cases, there is often a need to identify alarm groups that are highly correlated in time and (optionally) that are logically connected with a specific state or mode or with a triggering event. The alarm rationalization tool 144 operates to identify alarm groups that are candidates for mode-based suppression, event-based suppression, or other types of suppression.

In some embodiments, the alarm rationalization tool 144 could perform the following operations. A user can set search parameters specifying various (optional) filters and properties to be used when searching through a history of events, such as an alarm history recorded by the historian 128. These filters and properties can be used to perform an automated search for time-correlated events in the history. Events may occur frequently together within a specific (usually short) time interval, so they are assumed to be time-correlated. These filters and properties control which groups of alarms are identified for alarm rationalization, meaning these filters and properties can be used to control the types of alarms that are identified for possible suppression. An example filter or property can include specifying an amount of time in which a group of alarms may occur together (meaning alarms are identified as being time-correlated if they occur within the specified amount of time). Other example filters or properties can include searching for a specific order of alarms or searching specific time intervals related to equipment trips or other events of interest. Using these filters and properties, the alarm rationalization tool 144 can perform a search through the collected history of events to identify groups of alarms satisfying the user's search parameters.

The search results can be processed and presented to the user. For example, the presented results may summarize the alarm groups that have been identified and that are candidates to be dynamically suppressed. Other or additional steps could also occur. For instance, the user could select one or more of the identified alarm groups, and the alarm rationalization tool 144 could notify other components and systems and facilitate configuration of those components and systems in order to implement dynamic alarm suppression. Dynamic alarm suppression typically involves the suppression of a whole group of alarms that are usually related to a specific underlying event (such as a compressor trip or pump maintenance). When the underlying event takes place, most or all alarms of that group are temporarily suppressed.

In particular embodiments, the historian 128 could store data in one or more of a wide variety of formats, such as a relational database table, a flat file, a MICROSOFT EXCEL spreadsheet, or other format. Events in the database could include alarms and optionally other data such as operator changes. Each row in the database may correspond to one event that is further specified by a start time, an end time, a tag, and corresponding attributes. An example attribute for an alarm event could include an alarm type (such as HI, LO, or BADPV). Here, HI represents an alarm where an upper threshold is violated, LO represents an alarm where a lower threshold is violated, and BADPV represents an alarm where a process variable value cannot be determined by the respective sensor. Another example attribute for an alarm event is priority (such as emergency, high, or low). Additional alarm attributes may include an acknowledge time, an enable time, and a disable time. An example attribute for a device event may include a device type, such as an analog or digital meter, a wireless sensor, or other type of device. An example attribute for an operator change event may include a parameter (such as MODE, OP, or SP). Here, MODE represents a change of an operating mode, OP represents a change of an operating point, and SP represents a change of a setpoint. A user can control the search of the event history by adding constraints on any of these attributes or on other characteristics, such as constraints on time, alarms to be searched, or order of identified alarms.

Note that information other than historical alarm information can be searched by the alarm rationalization tool 144. For example, the alarm rationalization tool 144 can also search through operator actions or any other data collected by the historian 128. Also note that the alarm rationalization tool 144 could be used by any suitable personnel, such as a specialist, a process engineer, or other alarm rationalization team member during a thorough rationalization process or by a process engineer involved in continuous alarm system improvement.

The alarm rationalization tool 144 can provide various benefits depending on its implementation and use. For example, less overall alarm rationalization effort may be needed since the alarm rationalization tool 144 can produce advanced analysis automatically and can be scalable from a subset of alarms to an entire alarm database. The alarm rationalization tool 144 can also help an AR team focus more on advanced techniques of dynamic alarm suppression beyond the basic configuration techniques. In addition, the alarm rationalization tool 144 can provide objective insights into system performance. Unknown alarm groups and correlations can be discovered that may not be known by the operating crew or that were neglected or not communicated to the AR team. The alarm rationalization tool 144 can also eliminate human bias that may be present when alarm rationalization is done manually.

The alarm rationalization tool 144 may be implemented in the system 100 or other system in any suitable manner. For example, the alarm rationalization tool 144 could be implemented as an off-line desktop tool that analyzes alarms when the tool is initiated by a user. The alarm rationalization tool 144 could also be implemented remotely from the system 100 and used to analyze the historical event data collected by the historian 128. This could be done, for instance, as part of an on-line service. In general, each instance of the alarm rationalization tool 144 includes any hardware, software, firmware, or combination thereof for performing alarm rationalization operations. An alarm rationalization tool 144 could, for example, represent one or more software applications executed by one or more processors. The software applications could include a search engine and a user interface that allows users to specify search parameters and view search results.

Although FIG. 1 illustrates one example of a process control system 100, various changes may be made to FIG. 1. For example, a control system could include any number of each component shown in FIG. 1. Also, the makeup and arrangement of the process control system 100 in FIG. 1 is for illustration only. Components could be added, omitted, combined, or placed in any other suitable configuration according to particular needs. In addition, FIG. 1 illustrates one operational environment in which automated alarm rationalization techniques could be used. This functionality could be used in any other suitable device or system.

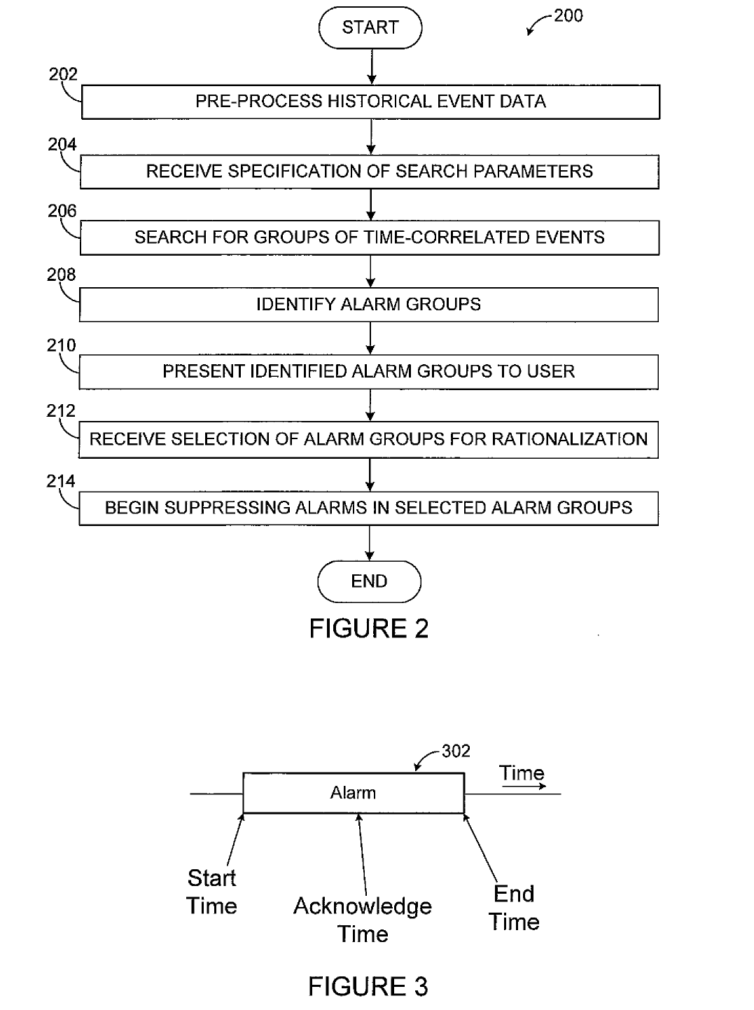

FIG. 2 illustrates an example method 200 for alarm rationalization using an alarm rationalization tool according to this disclosure. For ease of explanation, the method 200 is described with respect to the alarm rationalization tool 144 operating in conjunction with the process control system 100 of FIG. 1. The method 200 could be used with any suitable tool and in conjunction with any suitable system.

As shown in FIG. 2, historical event data can be pre-processed at step 202. This could include, for example, the alarm rationalization tool 144 taking steps to remove or ignore poorly acting alarms, such as “bad actors” like chattering alarms that repeat very frequently. As a particular example, if multiple instances of the same alarm occur within a specified (short) period of time, the alarm rationalization tool 144 could read those instances into a computer memory and combine them into a single instance of the alarm. The pre-processing step 202 could also include cleaning of the historical data in order to remove wrongly recorded alarms, such as those having two activations without any return event in between.

A specification of one or more search parameters is received at step 204. This could include, for example, the alarm rationalization tool 144 receiving information defining filters to be used when searching the historical event data. The filters could define constraints on time, such as by specifying whether a whole history (which may be the default) or only selected time intervals are searched. The filters could also define constraints on alarms to be searched, such as by specifying whether all alarms (which may be the default) or only a subset of alarms is searched. The filters could further define additional constraints on alarm attributes (which may have no constraints by default), such as alarms not acknowledged or alarms having a high or low priority. The filters could also indicate whether operator actions or other data is included in the search. Step 204 could also include the alarm rationalization tool 144 receiving restrictions on pattern properties to be used when searching history data. In some embodiments, the alarm rationalization tool 144 searches for patterns of events in the historical data, and the pattern properties could include an indication whether the patterns need to have a fixed order of events. The pattern properties could also include minimum and maximum distances (times) that need to exist between consecutive events in order for those events to be considered as an instance of a pattern.

A search for groups of time-correlated events is performed at step 206. This could include, for example, the alarm rationalization tool 144 searching through the event history in the historian 128 to identify alarms or other events that match the user's search parameters. As a particular example, the alarm rationalization tool 144 could search for and identify alarms or other events that appear in a pattern for at least a specified number of pattern occurrences. During the search, one or more alarm groups are identified at step 208. Among other things, the alarm rationalization tool 144 could identify combinations of alarms that frequently appear in the event history. The search may be called a data or pattern mining search or a pattern matching search since it is directed at finding patterns of events.

The identified alarm groups are presented to the user at step 210. This could include, for example, the alarm rationalization tool 144 presenting a graphical user interface (GUI) to the user, where the GUI identifies the alarm groups that are candidates for dynamic suppression. The alarm groups could be summarized in various ways, such as by ranking the alarm groups in order of the number of occurrences or by taking into account calculated “consistency” parameters for the identified groups.

At this point, the alarm rationalization tool could optionally receive a selection of one or more of the alarm groups at step 212 and take steps to initiate suppressing the alarms in the selected alarm group(s) at step 214. This could include, for example, the alarm rationalization tool 144 receiving a selection of one or more alarm groups through the GUI. This could also include the alarm rationalization tool 144 notifying other components of the process control system in FIG. 1 to begin dynamically suppressing alarms in the selected groups.

Although FIG. 2 illustrates one example of a method 200 for alarm rationalization using an alarm rationalization tool, various changes may be made to FIG. 2. For example, while shown as a series of steps, various steps in FIG. 2 could overlap, such as when some alarm groups are identified and presented to a user while searching of the event history continues. Also, various steps in FIG. 2 could be omitted, such as step 202 or steps 210-212. Further, some steps can be executed several times in a loop, such as returning from step 210 back to step 202.

FIGS. 3 through 12 illustrate example details associated with an alarm rationalization tool according to this disclosure. For ease of explanation, FIGS. 3 through 12 are described with respect to the alarm rationalization tool 144 operating in conjunction with the process control system 100 of FIG. 1 and performing the method 200 of FIG. 2. Other alarm rationalization tools could be used in conjunction with any suitable system and method.

FIGS. 3 through 7 illustrate example details regarding search parameter specification, which occurs during step 204 in FIG. 2. As shown in FIG. 3, an event 302 like an alarm typically has some duration, and there are often different times associated with the event 302. In some embodiments, each alarm event 302 may be treated as one or more points in time (rather than as intervals). For an alarm, those points in time could include a start time when the alarm is initiated, an acknowledge time when the alarm is acknowledged by a human operator, and an end time when the alarm is resolved or stops. For an operator action event, there may be only a start time and no duration, and each operator action event is a point-in-time event. Depending on the implementation, the search for patterns in step 206 could consider only the start time for each uniquely defined event 302, or other event parameters (such as end time or acknowledge time) can also be used for mining.

As noted above, during specification of the search parameters at step 204, a user could specify various filters to be used when searching the event history. The filters could include a specification of the time period to be searched, the alarm/event types to be searched, or other event-related restrictions. These filters could be specified, for example, using a GUI.

During specification of the search parameters at step 204, the user could also specify various restrictions on pattern properties. The pattern properties could include a definition of whether the order of events in a pattern is completely, partially, or not fixed. In general, a pattern could be defined by a set of events occurring in a specific order and/or a set of events occurring in any order during a specified interval.

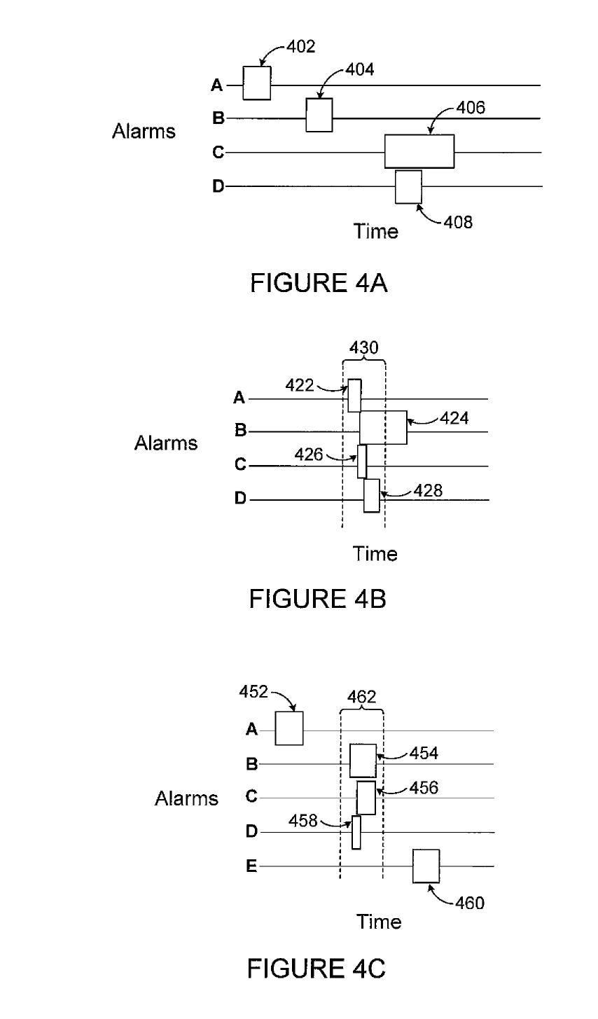

Consider FIGS. 4A through 4C as examples. In FIG. 4A, a pattern formed by events 402-408 is completely fixed in terms of event order. In this example, an occurrence of this pattern is found in the event history only when the events 402-408 occur in this exact order within some maximum time period. If the events 402-408 occur in a different order, no pattern match is found. If the events 402-408 occur in this order over some period longer than the maximum defined time, again no pattern match is found. This type of pattern is said to define a “sequence” without “co-occurrences,” meaning the events must occur in a given sequence without order changes to be counted as a pattern match.

In FIG. 4B, a pattern formed by events 422-428 is completely unfixed in terms of event order. In other words, it is the presence of the events 422-428 within a specified time interval 430 that defines the pattern, not the order of the events 422-428. An occurrence of this pattern is found in the event history when these events 422-428 are located within the time interval 430, regardless of order. This pattern is said to define “co-occurrences” without “sequence,” meaning the events 422-428 must occur within a specified time period to be counted as a pattern match, regardless of order.

In FIG. 4C, a pattern formed by events 452-460 is partially fixed in terms of event order. In this example, the pattern requires the event 452 to be first and the event 460 to be last. The events 454-458 can occur in any order during a specified time interval 462. This pattern is said to define a “sequence” with “co-occurrences,” meaning some events must have a specific order while other events must occur within a specified time period regardless of order.

In some embodiments, the GUI presented by the alarm rationalization tool 144 to a user allows the user to define the types of patterns to be found during the search. For example, when defining the filters and other search parameters, the GUI could allow the user to indicate whether the user wishes to search for patterns that are completely, partially, or not fixed in terms of event order.

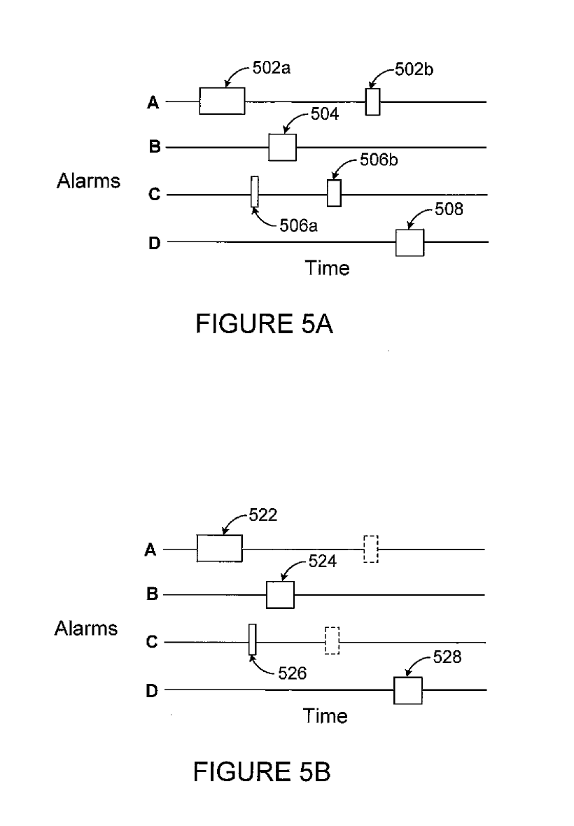

During specification of the search parameters at step 204, the user could also specify whether to remove duplicate events when searching for a pattern. In some instances, a user may wish to locate patterns that can have multiple instances of the same event. An example of this is shown in FIG. 5A, where a pattern includes two instances of a first event 502a-502b, a second event 504, two instances of a third event 506a-506b, and a fourth event 508. If this pattern is a sequence without co-occurrences, this pattern is not found in the event history unless the exact sequence of events shown in FIG. 5A occurs, including the two repeat events 502b and 506b.

In other instances, the user may wish to locate patterns where duplicate events are irrelevant. An example of this is shown in FIG. 5B, where a pattern includes four events 522-528. If this pattern is a sequence without co-occurrences, this pattern is not found in the event history unless the exact sequence of events as shown in FIG. 5B occurs, but duplicate events within a specified interval are not considered.

In some embodiments, the GUI presented by the alarm rationalization tool 144 to a user allows the user to select whether to include or disregard duplicate events. If the user chooses to disregard duplicate events, the user could also specify the time interval during which duplicate events are ignored.

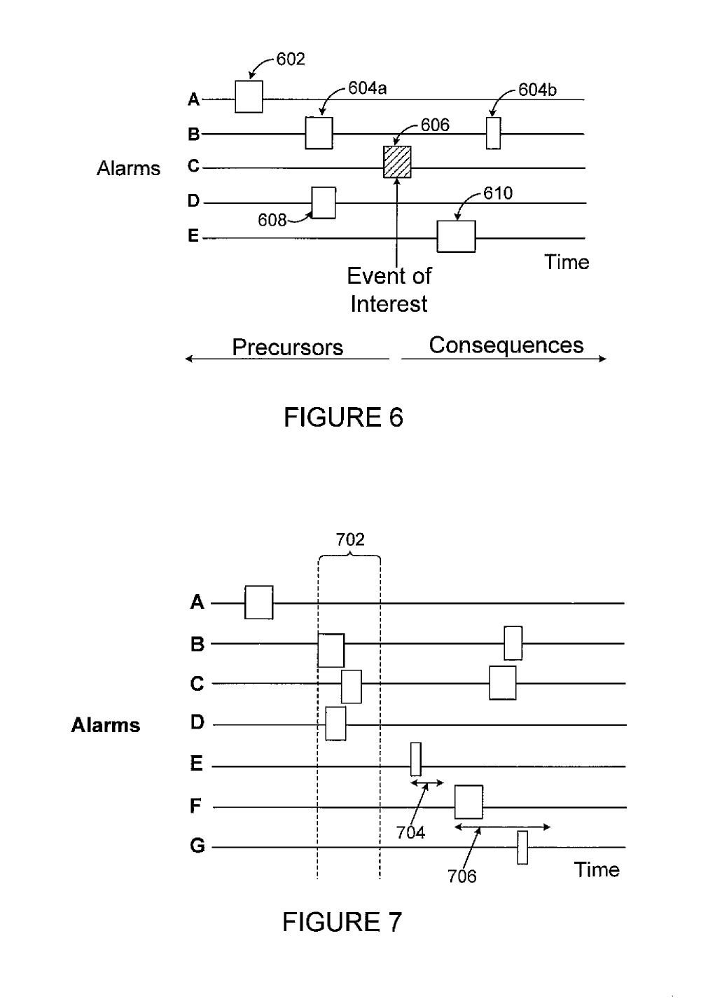

During specification of the search parameters at step 204, the user could further specify whether to search for precursor events, consequence events, or both. This can be used during a focused search to identify patterns that occur around equipment trips or other specified events of interest. An example of this is shown in FIG. 6, where various events 602-610 are shown. One of the events, event 606, represents an event of interest. Events prior to the event of interest 606 are denoted precursors, and events after the event of interest 606 are denoted consequences.

In some embodiments, the GUI presented by the alarm rationalization tool 144 allows the user to specify whether the user wishes to perform a focused search using particular events of interest or some other type of search. If the user wishes to perform a focused search using an event of interest, the user can identify the event of interest and specify whether to search for patterns containing precursor events, consequence events, or both. Of course, patterns can also be defined independent of any event of interest.

In addition, during specification of the search parameters at step 204, the user could specify pattern restriction parameters. The pattern restriction parameters represent various restrictions placed on patterns, some of which are shown in FIG. 7. For co-occurrence patterns, one pattern restriction parameter could be the time interval 702 for a co-occurrence set of events. This interval 702 denotes the time period in which multiple events need to occur in order to be considered related. For sequence patterns, the pattern restriction parameters could include a minimum time interval 704 and a maximum time interval 706 between events. These intervals 704-706 define the minimum and maximum times that separate two events in order for the two events to be considered related.

Another pattern restriction parameter could be a minimum number of occurrences that need to be found for a pattern in the historical data before the alarm rationalization tool 144 reports that pattern to the user. This may allow, for example, the user to avoid seeing patterns with one or a few occurrences.

In some embodiments, the GUI presented by the alarm rationalization tool 144 to a user allows the user to define the pattern restriction parameters. In particular embodiments, pattern restriction parameters can be manually set, or the user could select one of multiple recommended settings. Manual settings allow the user to select parameters to meet specific objectives.

Recommended settings could be associated with multiple pre-defined scenarios. A recommended setting could include any of the following parameters:

Identify patterns with a (short, middle, long) distance between alarms, which may typically reflect the process dynamics (i.e. short distances can be used for fast processes and long distances for slow processes);

Identify patterns with (fixed, variable) order; or

Identify patterns that are the (most, middle, least) occurring.

Combinations, such as short patterns that occur most frequently, could also be selected by the user. The particular settings for parameters in a selected scenario can be based on the automatic analysis of the event history. For example, the length of short, middle, and long patterns need not be specified by the user and can instead be determined by the alarm rationalization tool 144 during an analysis of the historical event data. As a particular example, the alarm rationalization tool 144 could detect all patterns with two events during loading of the historical data. The alarm rationalization tool 144 could calculate a histogram of the distances between alarms of all patterns and calculate the number of occurrences for each pattern. Using this information, the alarm rationalization tool 144 could estimate search parameters from the histogram, the number of occurrences, and the selected setting.

During the search of the historical data at step 206 and identification of the alarm groups at step 208, the alarm rationalization tool 144 could perform various types of searches. For example, a focused search can be performed when the user is interested in patterns related to one or more particular events of interest (such as an equipment trip or a change of a process state). The performance of a focused search could be selected using the GUI or by using a flag or other information in the event history database. The alarm rationalization tool 144 could also perform an exhaustive search in which the alarm rationalization tool 144 attempts to discover all significant patterns in specified historical data (either all data or a subset of the data).

In some embodiments, the search algorithm used by the alarm rationalization tool 144 could have any of the following capabilities. The search algorithm can identify frequent groups of alarms that have a fixed, variable, or partially variable order. The search algorithm can identify frequently repeating patterns (such as by using the technique described below) even when their occurrences are masked by other (“noise”) alarm instances. The search algorithm can further analyze relationships between alarms and operator actions, handle time constraints on a pattern, and remove duplications in a pattern.

As described above, the search operation in step 206 can be used to identify certain relationships based on the order that events appear in the event history. The following details specify the problem of event pattern mining and provide one example of an effective mining technique. More specifically, the following describes a general technique for automatically searching for frequent time-correlated event groups or patterns in an event history, with the objective of supporting alarm rationalization. As noted above, the events can include alarms generated by a control system and may or may not include other events like actions applied by human operators when controlling a process. As a particular example, patterns may correspond to specific situations that cause activation of alarms, followed by operator actions such as adjustments of setpoints or operating modes. In the following description, each event can be uniquely defined by a start time and a name, and the events can be stored in a single time-ordered sequence. Several additional attributes (such as acknowledge time, end time, actual value, and priority) can also be used for detailed specification of each event.

An event history (such as in the historian 128) often contains many alterations of similar patterns that differ by time distance between consecutive events or order of events. An event group can be classified as a pattern if the number of occurrences (support) in the event history is higher than a given minimum count and fulfils any pattern restrictions specified by the user. There are various techniques for time-correlated data mining. Searching patterns in a single time-ordered sequence is sometimes called “mining of frequent episodes.” However, a practical disadvantage of conventional methods is that they only count the support of the simple patterns without actively using pattern restrictions. A more flexible problem formulation can be used that allows for mining of restricted patterns.

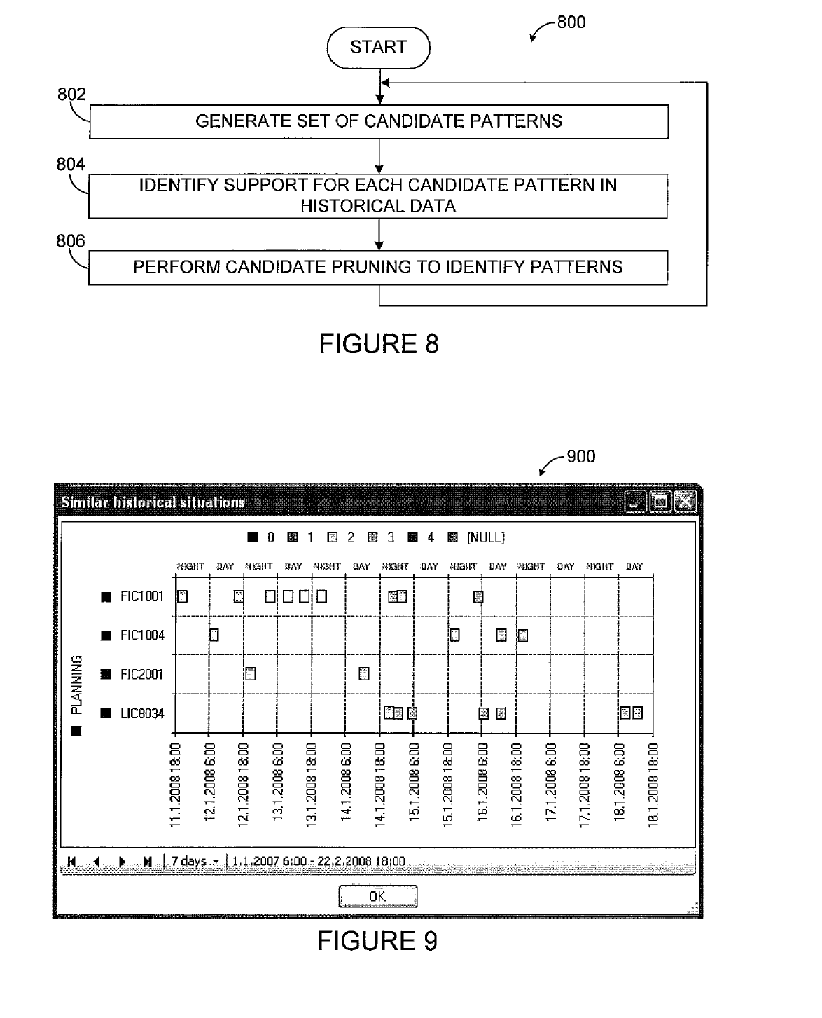

One possible pattern mining algorithm for mining of restricted patterns is shown in FIG. 8. This pattern mining technique includes iteratively repeating three steps 802-806. The alarm rationalization tool 144 can first generate a list of possible pattern candidates at step 802, meaning the alarm rationalization tool 144 identifies events that might form patterns in the historical data. The alarm rationalization tool 144 then searches for the number of occurrences (support) of each identified candidate pattern at step 804. After that, the alarm rationalization tool 144 engages in candidate pruning at step 806, where the alarm rationalization tool 144 determines whether the number of occurrences for any of the pattern candidates exceeds some minimum amount. Candidate patterns that do not exceed the minimum amount can be discarded. Candidate patterns having a low pattern homogeneity can also be discarded. This process can be repeated any number of times to identify patterns having some minimum support in the event history.

This technique generally involves searching for frequent sequences of events (such as alarms and/or operator changes). However, only those sequences having at least a specified minimum count of occurrences in the history database and having a value of pattern homogeneity less than a specified threshold may be acknowledged as patterns. The support count of a sequence is increased by one when the search algorithm finds an occurrence of a sequence satisfying the defined time constraints (such as the minimum distance, the maximum distance, and the co-occurrence interval) on a pattern. The occurrences of the sequence may be found by any suitable sequential pattern mining technique. The pattern homogeneity H of a candidate sequence can be defined as the variance of distances between consecutive sequence elements for all candidate occurrences (support) Nₒ, averaged over length N of the candidate. This can be expressed as:

$$H = \frac{1}{N - 1} {\sum }_{k = 1}^{N - 1} ( \frac{1}{{N}_{o}} {\sum }_{i = 1}^{{N}_{o}} {( Δ {t}_{k , i} - {μ}_{k} )}^{2} ) ; {μ}_{k} = \frac{1}{{N}_{o}} {\sum }_{i = 1}^{{N}_{o}} Δ {t}_{k , i} \qquad ( 1 )$$

where Δt_{k,i}=t_{k+1,i}−t_{k,i} denotes the k-th start-time difference between consecutive events in the N-candidate sequence for its i-th occurrence in the database. Pattern homogeneity is the measure of similarity between individual candidate occurrences. The smaller the measure, the greater the similarity.

This algorithm, denoted as an exhaustive search, can be used to detect all patterns in a given database or a specified subset of the database. A focused search can be implemented as a special mode of this algorithm that searches only for patterns containing a user-selected event. The candidate generation step 802 can be modified to produce only candidates that are required for the focused pattern determination, such as by concatenating N=patterns containing the selected event only with two-patterns. The algorithm thus evaluates a significantly lower number of candidates, which reduces the computation time.

During presentation of the search results to the user at step 210, the alarm rationalization tool 144 can present the identified alarm groups in any suitable manner. For example, the alarm rationalization tool 144 could provide a ranked list of patterns that are selected or filtered from the search results. The patterns could be ranked in any suitable manner, such as by being ranked according to (i) the number of occurrences of the patterns, (ii) the length (number of events) in the patterns, (iii) alarm attributes such as priority or if the alarm was followed by an operator's action, and (iv) calculated “consistency” or homogeneity values.

The alarm rationalization tool 144 could determine the consistency values using event attributes such as the relative distance between the start times of consecutive events in an identified pattern, the duration of individual events, and the acknowledge time of individual events (measured as the relative distance from its respective start time). The alarm rationalization tool 144 could compute the pattern consistency by finding all occurrences of a selected pattern in the database and computing the average distance from the overall mean value of each attribute. Smaller average distances may indicate a pattern is more consistent with respect to the chosen attribute. As particular examples, the alarm rationalization tool 144 could present a list of the top 10% most consistent patterns, a list of the most consistent patterns given an upper bound of the average distances, or information identifying the overall quality of a selected pattern using graphical or other aids.

The alarm rationalization tool 144 could also graphically display identified patterns to a user, such as by using a graphical user interface 900 like the one shown in FIG. 9. The GUI 900 could identify different patterns on the vertical axis of a bar plot and time on the horizontal axis of the bar plot. The bars in the GUI 900 could identify the different times when the associated patterns were detected.

Other graphical displays could also be generated by the alarm rationalization tool 144. For example, alarm rationalization is a versatile process that may require analysis of different aspects, and several modifications of the pattern mining algorithm can be used to cover various application scenarios such as those summarized in Table 1.

TABLE 1

| Event types | Exhaustive search | Focused search |
|---|---|---|
| Alarms only | Frequent episodes | Precursors and |
| | | consequences |
| Actions only | Operator practices | Operator practices |
| Alarms & | Extended episodes | Post-incident |
| actions | | |

As noted above, two modes of the search algorithm are exhaustive and focused searches. Also, searched patterns may include one or more types of events (such as alarms and operator actions). Combining these options can lead to various scenarios, such as the following.

“Frequent episodes” is a mining scenario that discovers all existing event patterns (within any specified constraints) that might be more closely examined in further steps.

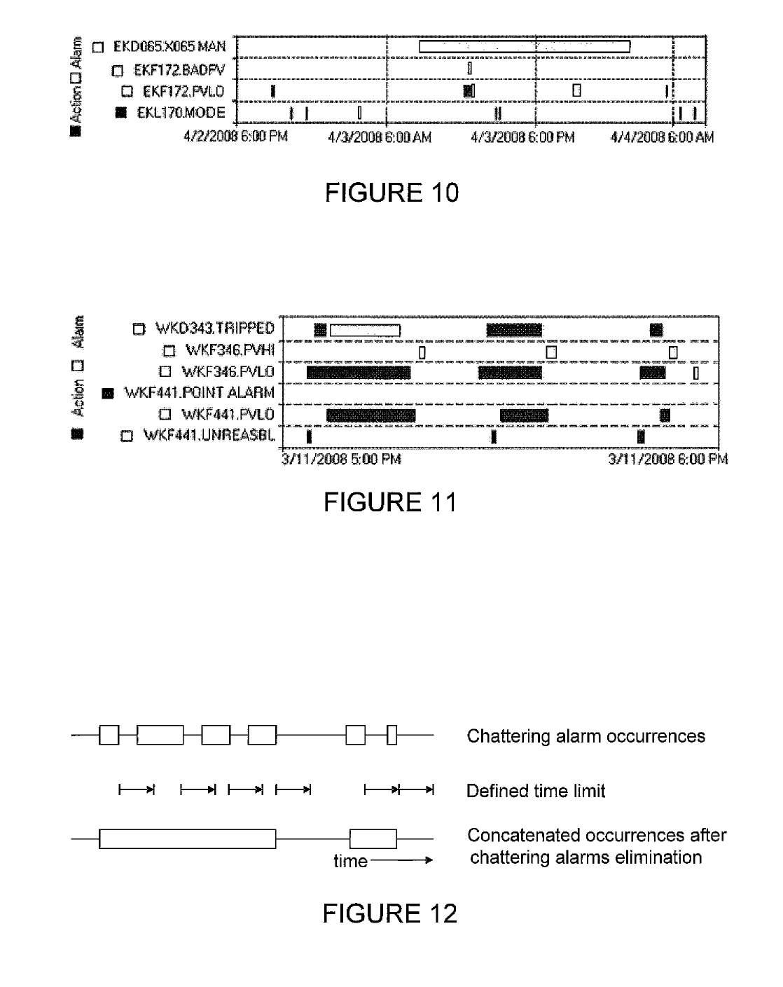

“Extended episodes” is a mining scenario that identifies typical actions of operators in connection with certain alarm patterns, and it can be used for operator training. An example of an extended episode is shown in FIG. 10, which illustrates that an operator changing the EKL170.MODE parameter twice after the occurrence of the EKF172.PVLO alarm was detected as a significant pattern. The results of the extended episodes scenario may be compared with frequent episodes to analyze the consistency of operator actions in connection with specific alarm patterns. This analysis can help to find out whether an individual operator or different operators solve the same alarm situation differently and how. Another possible usage is in the detection of actions causing extensive amounts of alarms.

An “operator practices” mode allows for comparing operator action patterns of different operators. The results can be used for training and improving operating practices. The identified patterns may also be used to generalize the outcome of a previous scenario in case the same action pattern appears in two or more extended episodes.

A “precursors and consequences” mode may correspond to optimizing alarm configurations by picking alarms one by one. In this mode, the pattern mining outputs are either the precursors (events typically preceding a selected event), the consequences (events typically succeeding the selected event), or both. One way to implement this mode is to run extended episodes first to identify events of interest. An example of identified precursors of a specific alarm is presented in FIG. 11, which shows the precursors of the WKF441.PVLO alarm (where pattern appearances are highlighted). The pattern here includes the events {(WKD343.TRIPPED, WKF346.PVLO, WKF441.UNREASBL) WKF441.PVLO}. The { } notation defines the events within the pattern, and the ( ) notation defines co-occurrence events. In this example, the pattern includes the first three events in any order, followed by the WKF441.PVLO event.

A “post-incident” analysis scenario may be exploited in operator training by identifying various series of actions repeatedly leading to a specific incident.

All of the above usage scenarios may be influenced by user-specified time constraints on a pattern (such as minimum distance, maximum distance, and co-occurrence interval). The constraint settings may depend on whether the user is focused on patterns with events appearing in shorter or longer time intervals, which would be typically reflecting faster or slower dynamics of the given process. The constraint settings may also be defined automatically by analyzing distances between database elements as described above. In addition, the user may define the pattern maximum length or search only for patterns where each type of event occurs only once. Any of these usage scenarios can have results presented in any suitable GUI or presented in any other suitable manner.

To prevent overloading of the search algorithm and to reduce processing of redundant or “noise” information, bad actors (such as chattering alarms) may optionally be identified and handled during step 202. A chattering alarm typically switches on and off repeatedly so quickly that it cannot be caused by operator action or process value changes. Rather, chattering alarms are often caused by inaccurate process value measurements or poorly maintained alarm configurations. As a particular example, a chattering alarm may be activated and cleared at least three times in a minute (thus extensively increasing the overall alarm rate) while conveying little or no information to an operator.

This problem can be handled, for example, using deadband filters or debounce timers (ON-delay or OFF-delay) during data preprocessing. An example of using an OFF-delay timer is shown in FIG. 12, where multiple instances of a specific chattering alarm can be concatenated into one single instance of the alarm lasting over the whole chattering period. The instances of the chattering alarm that are concatenated represent pairs of instances that occur within a time limit defined by the OFF-delay timer.

In general, the search algorithm's performance may depend on the size and pattern density of the analyzed historical database and on any user-specified constraints, such as user-specified time constraints on a pattern. To prevent overloading of the algorithm, the amount of data processed by the algorithm in one run may be reduced. This could be done by searching only over time intervals revealing alarm floods or by splitting the search to analyze individual groups of alarms that are equipment- and/or process-related (since it is not expected that meaningful correlations would exist across physically unrelated alarm groups). A similar strategy may also be implemented in case an overall analysis is not required.

The resulting patterns that are identified and presented to a user may be further used in any suitable manner. For example, these patterns can provide an AR team with information on correlated alarm groups to increase the effectiveness of the process of alarm system configuration revision. As another example, these patterns can be selected for suppression. More specifically, this allows identification of alarm groups that routinely, always, or almost always occur during a specific triggering event (such as a compressor trip or a pump being turned off for maintenance). These patterns can therefore be exploited for dynamic alarm suppression of alarm patterns associated with an operating mode (such as process start-up) or a specific triggering event (such as suppressing low-flow alarms when a pump is turned off for maintenance). When the alarm suppression is actually implemented and the triggering event takes place, an operator may be notified by one single alarm, not by the whole group of alarms that are now suppressed. This avoids operators being flooded with useless alarm information (which is otherwise valuable under normal conditions).

Although FIGS. 3 through 12 illustrate examples of details associated with an alarm rationalization tool, these details relate to a specific implementation of an alarm rationalization process and a pattern mining algorithm. Other or additional steps could occur during the alarm rationalization process, and other search algorithms can be used.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving at least one search parameter, the at least one search parameter defining one or more restrictions on types of event patterns;
searching a collection of historical events associated with a process control system;
identifying one or more groups of alarms each having a pattern that satisfies the one or more restrictions; and
outputting information identifying the one or more groups of alarms.

2. The method of claim 1, further comprising:
receiving a selection of at least one of the one or more identified groups of alarms; and
notifying one or more components in the process control system to begin dynamically suppressing alarms in the at least one selected group of alarms.

3. The method of claim 2, wherein:
each selected group of alarms includes multiple alarms; and
dynamically suppressing one selected group of alarms comprises preventing at least one of the multiple alarms in the selected group from being presented to an operator.

4. The method of claim 1, wherein the one or more restrictions comprise an indication whether events in patterns to be found are fixed, partially fixed, or not fixed in order.

5. The method of claim 1, wherein the one or more restrictions comprise an indication whether duplicate events within a specified time period are viewed as separate events.

6. The method of claim 1, wherein the one or more restrictions comprise an indication whether patterns to be found include events preceding a specified event of interest, events following the specified event of interest, or both.

7. The method of claim 1, wherein the one or more restrictions comprise an indication of which types of events are searched in the collection of historical events.

8. The method of claim 1, wherein searching the collection of historical events comprises iteratively:
identifying multiple candidate patterns;
identifying a number of occurrences of each candidate pattern in the collection of historical events; and
discarding each candidate pattern whose number of occurrences falls below a threshold value.

9. The method of claim 1, further comprising:
identifying multiple instances of the same event that occur within a specified time of each other in the collection of historical events; and
concatenating the multiple instances of the same event into a single instance of the event.

10. An apparatus comprising:
a processing device configured to:
receive at least one search parameter, the at least one search parameter defining one or more restrictions on types of event patterns;
search a collection of historical events associated with a process control system; and
identify one or more groups of alarms each having a pattern that satisfies the one or more restrictions; and
a memory device configured to store information identifying the one or more groups of alarms.

11. The apparatus of claim 10, wherein the processing device is further configured to:
receive a selection of at least one of the one or more identified groups of alarms; and
notify one or more components in the process control system to begin dynamically suppressing alarms in the at least one selected group of alarms.

12. The apparatus of claim 11, wherein:
each selected group of alarms includes multiple alarms; and
the processing device is configured to dynamically suppress one selected group of alarms by preventing at least one of the multiple alarms in the selected group from being presented to an operator.

13. The apparatus of claim 10, wherein the one or more restrictions comprise an indication whether events in patterns to be found are fixed, partially fixed, or not fixed in order.

14. The apparatus of claim 10, wherein the one or more restrictions comprise an indication whether duplicate events within a specified time period are viewed as separate events.

15. The apparatus of claim 10, wherein the one or more restrictions comprise an indication whether patterns to be found include events preceding a specified event of interest, events following the specified event of interest, or both.

16. The apparatus of claim 10, wherein the processing device is configured to search the collection of historical events by iteratively:
identifying multiple candidate patterns;
identifying a number of occurrences of each candidate pattern in the collection of historical events; and
discarding each candidate pattern whose number of occurrences falls below a threshold value.

17. The apparatus of claim 10, wherein the processing device is further configured to:
identify multiple instances of the same event that occur within a specified time of each other in the collection of historical events; and
concatenate the multiple instances of the same event into a single instance of the event.

18. A computer readable medium embodying a computer program, the computer program comprising:
computer readable program code for receiving at least one search parameter, the at least one search parameter defining one or more restrictions on types of event patterns;
computer readable program code for searching a collection of historical events associated with a process control system;
computer readable program code for identifying one or more groups of alarms each having a pattern that satisfies the one or more restrictions; and
computer readable program code for outputting information identifying the one or more groups of alarms.

19. The computer readable medium of claim 18, further comprising:
computer readable program code for receiving a selection of at least one of the one or more identified groups of alarms; and
computer readable program code for notifying one or more components in the process control system to begin dynamically suppressing alarms in the at least one selected group of alarms.

20. The computer readable medium of claim 18, wherein the computer readable program code for receiving the at least one search parameter comprises computer readable program code for generating a graphical user interface, the graphical user interface configured to receive from a user:
an indication whether events in patterns to be found are fixed, partially fixed, or not fixed in order;
an indication whether duplicate events within a specified time period are viewed as separate events; and
an indication whether patterns to be found include events preceding a specified event of interest, events following the specified event of interest, or both.
